(19) United States
(12) Patent Application Publication
(10) Pub. No.: US 2007/0113083 A1
(43) Pub. Date: May 17, 2007

(54) SYSTEM AND METHOD OF MESSAGE AUTHENTICATION

(76) Inventors: Nikolajs VOLKOVS, Toronto, ON (CA); Vijaya Kumar MURTY, Toronto, ON (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 11/457,669

(22) Filed: Jul. 14, 2006

Related U.S. Application Data
(60) Provisional application No. 60/698,968, filed on Jul. 14, 2005.

(51) Int. Cl. H04L 9/00

(52) U.S. Cl. 713/168

(57) ABSTRACT

A system and method of improving the resistance of MAC functions to attack makes use of the output MAC value to perform a one-way operation such as exponentiation in a cyclic group such as a Galois Field. Further enhancements are provided by an optional keyed function that can provide another barrier through which an attacker must break. The application of a keyed function can also be applied to hashing functions so that they have the qualities of a MAC function and additionally benefit from the application of the one way operations to improve security.

### CROSS REFERENCE TO RELATED APPLICATIONS

This application claims the benefit of priority of U.S. Provisional Patent Application No. 60/698,968 filed Jul. 14, 2005, which is incorporated herein by reference.

### FIELD OF THE INVENTION

The present invention relates generally to methods of authenticating messages. More particularly, the present invention relates to enhancing Message Authentication Code and cryptographic hashes to provide further resistance to tampering.

### BACKGROUND OF THE INVENTION

Hash and Message Authentication Code (or MAC) algorithms are extremely important and, at the same time, the most vulnerable components of network security. These algorithms are used to provide a hash or MAC value that can serve as authentication of the integrity of a message that they have been appended to. A recipient user can perform the same hash or MAC operation on the received data to obtain statistical verification that the data has not been modified in transit. It should be noted that because hash and MAC algorithms produce tags of a fixed size for inputs of all lengths, the mapping is a many-to-one mapping, which results in “hash collisions”. Hash collisions result when two messages have the same hash or MAC value. Typically, a combination of the hash or MAC value and the message size is considered as sufficient to provide the statistical verification. The design of the algorithms is intended to generate widely divergent hash and MAC values for slightly different inputs which provides an easy to recognize indication of message alteration. It should further be noted, that MAC algorithms make use of a key in their generation of the tag. It is known that if the key is known, collisions can be easily designed to occur. This is not considered a security flaw, as the key is designed to be a secret.

In a recent development, several of the main hash algorithms (such as MD-5, RIPEMD) and hash algorithms of the SHA family (such as SHA-0, SHA-1) were somewhat compromised.

A typical secure hash function is generally referred to as an iterated hash function, and it is based on a proposal by Merkle, as per R. C. Merkle, Authentication and Public Key systems, Ph. D. Thesis, Stanford University, June 1979, and R. C. Merkle, One way hash functions and DES, in: Advances in Cryptology—Crypto '89, ed. G. Brassard, pp. 428-446, Lecture Notes in Computer Science 435, Springer-Verlag, 1990. According to Merkle's proposal, the hash function takes an input string of bits and partitions the string into fixed-sized blocks of size k. Then a compression function takes k bits of the i-th partition and m bits from the previous calculation and calculates m bits of the (i+1)-st iteration. The output value of the last iteration (of size m) is the hash value. One common hash function is Message-Digest algorithm 5 (MD5) which generates 1280-bit hash values. Flaws were identified in the MD5 algorithm in 1996, leading many organizations to suggest that MD5 not be relied upon as secure.

The secure hash function SHA was designed by the National Security Agency (NSA) and issued by NIST in 1993 as a Federal Information Standard (FIPS-180). A revised version called SHA-1, which specifies an additional round to the message expansion, was later issued in 1995 as FIPS-180-1. Further revisions, to the SHA family of algorithms include SHA-224, SHA-256, SHA-384, and SHA-512 which are occasionally collectively referred to as SHA-2.

SHA-1 produces a 160-bit hash. That is, every message hashes down to a 160-bit string. Given that there are an infinite number of messages that hash to each possible value, there are an infinite number of possible collisions. But because the number of possible hashes is so large, the odds of finding a collision by chance is small (one in 2⁸⁰, to be exact). Thus, using the brute-force method of finding collisions, the success of the attack depends solely on the length of the hash value.

Hash and MAC functions are considered to be broken if it can be demonstrated that it is possible to find collisions using an algorithm in fewer comparisons than would be required if brute force was applied. One of the known brute force attacks directed at the SHA family involves attempting to discern the key used. With access to the key, the algorithm is compromised as it becomes much easier to design documents to have the same hash as other documents. For an m-bit length key, a key attack will typically require approximately 2^{(m-1)/2} attempts to determine the key. Therefore, for a 160-bit key, any possible attack that requires less than 2⁸⁰ attempts to create a collision is considered a threat. Further details about existing hash and MAC functions can be found in chapter 9 of A. J. Menezes, P. C. van Oorschot, S. A. Vanstone, Handbook of Applied Cryptography, CRC Press, 1997. or in chapters and 9 of W. Stallings, Cryptography and Network Security: Principles and Practice, 2nd edition, Prentice Hall, 1999.

By the recommendation of NIST, SHA-1 has been replaced by SHA-256, SHA-384, and SHA-512 (Secure Hash Signature Standard (SHS) (FIPS PUB 180-2)). However, as the algorithms SHA-1, SHA-256, SHA-384, and SHA-512 have common constructions, the same attack, that has already been used in the case of SHA-1, can be applied to SHA-256, SHA-384, and SHA-512. Furthermore, there is no guarantee that the attack will not be further enhanced. Hence, all the systems of the SHA family may eventually be compromised.

When a MAC or hashing algorithm is compromised, the conventional recommendation is to abandon the algorithm and move to a more secure algorithm. This requires that electronic infrastructure used to generate the hash or MAC values must be updated, which involves moving a large installed base to another system. For obvious reasons, including user inertia, this is a difficult task. Thus, there is a need, for methods, computer programs and computer systems that, while utilizing hash and MAC algorithms (such as the MAC algorithms of the SHA family), are operable to provide an improved level of security. There is a further need for the methods, computer programs and computer systems that meet the aforesaid criteria and are further easy to implement to existing technologies and are computationally feasible.

### SUMMARY OF THE INVENTION

It is an object of the present invention to obviate or mitigate at least one disadvantage of previous hashing and message authentication code methods and systems.

In a first aspect of the present invention, there is provided a method of enhancing the security of a Message Authentication Code (MAC) function having a MAC function key. The method comprises the steps of applying the MAC function to a message to obtain a MAC value; and generating an authentication token associated with the message, to prevent direct access to the MAC value, by applying a one-way function to the MAC value.

In an embodiment of the first aspect of the present invention, the MAC function is a SHA-based MAC function. In other embodiments, the method includes the step of applying a keyed function to the MAC value prior to applying the one way function, where the keyed function has a keyed function key that can be distinct from the MAC function key. In a further embodiment, the one-way function is applied in a cyclic group such as exponentiation of the MAC value in a Galois field such as GF(2^{t}) using the field generator. In other embodiments, the length of the authentication token is identical to the length of the MAC value. In further embodiments, the length of the authentication token exceeds the length of the MAC value, and the one way function can be applied in a cyclic group having a size equal to the length of the authentication token.

In a second aspect of the present invention, there is provided a method of enhancing a hashing function to operate as an enhanced Message Authentication Code (MAC) function. The method comprises the steps of applying the hashing function to a message to obtain a hash value; applying a keyed function to the hash value to obtain a keyed hash value; and generating an authentication token associated with the message, to prevent direct access to the hashed value, by applying a one-way function to the keyed hash value.

In embodiments of the second aspect of the present invention, the hash function is the MD5 function. The one-way function can be an exponentiation of the hashed message in cyclic group. In some embodiments, the length of the authentication token exceeds the length of the hashed message, and the one way function can be applied in a cyclic group having a size equal to the length of the authentication token.

In a third aspect of the present invention, there is provided a system for generating an authentication token associated with an input message. The system comprises a message authentication code engine and an authentication token generator. The message authentication code engine generates a message authentication value associated with the message. The authentication token generator performs a one-way function on the message authentication value to generate the authentication token.

In embodiments of the third aspect of the present invention, the authentication token generator includes an exponentiator for generating the authentication token by exponentiating the message authentication value in a cyclic finite group. The system can also include a keying engine for applying a keyed function to the message authentication value to obtain a keyed message authentication value and for providing the authentication token generator with the keyed authentication value, wherein the authentication token generator performs the one-way function on the keyed message authentication value to generate the authentication token.

In a fourth aspect of the present invention, there is provided a system for generating an authentication token associated with an input message. The system comprises a hashing engine, a keying engine and an authentication token generator. The hashing engine generates a hash value associated with the message. The keying engine applies a keyed function to the hash value to obtain a keyed hashed value. The authentication token generator performs a one-way function on the keyed hash value to generate the authentication token.

In an embodiment of the fourth aspect of the present invention, the authentication token generator includes an exponentiator for generating the authentication token by exponentiating the keyed hash value in a cyclic finite group.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a flowchart illustrating a method of enhancing a MAC function;

FIG. 2 is a flowchart illustrating a method of providing MAC functionality to hashing functions; and

FIG. 3 is a block diagram of an exemplary system of the present invention.

### DETAILED DESCRIPTION

Generally, the present invention provides a method and system for performing hashing and MAC operations on input messages while enhancing the security of existing methods.

In the following description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention. For example, specific details are not provided as to whether the embodiments of the invention described herein are implemented as a software routine, hardware circuit, firmware, or a combination thereof.

A design feature of a MAC algorithm is that if the key is not known, it is computationally infeasible to generate the corresponding MAC-value. The present invention provides a method for increasing the security of any MAC algorithm by adding the step of a further transformation of the MAC-value itself, as generated by the MAC algorithm. In accordance with the present invention: (1) first, the MAC-value is generated by a secure hash, which MAC-value is kept secret; and (2) in addition, a further transformation, as described below, is applied to the MAC-value.

The below-described method can also be applied to hash functions, and the use of a key in the second function introduces an added layer of security not previously present. Thus, the application of the security enhancing method of the present invention enhances a hash function to have the security of a MAC function.

To protect a MAC-value from attack, another layer of security is applied by performing a further operation on the MAC-value. The result of this further operation is then used in the place of the MAC value. By transmitting the result of the further operation (herein referred to as the TR value) the MAC value is kept from malicious third parties. Thus, to attack the MAC function, the TR function must be broken. Thus, the TR function serves to wrap the MAC function in a further layer of security. If the TR function is found to have a flaw, the modular nature of systems and methods of the present invention allow for the TR function to be updated without disturbing the underlying MAC or hash function.

A representative MAC-value is designated by h, generated by a MAC algorithm H. To make explicit the dependence on the key, we write H_{K}. In addition, the further transformations referred to above and which are applied to h are designated F and TR. If M is a message, and K is a key, then we have the following chain of transformations of the message M:
H_{K}:M→h,
F:(K,h)→f,
TR:f→w

There are several ways in which a suitable function F can be defined. The simplest instance of this is to choose F(K, h)=h. Alternatively, if, for instance, the sizes K and h=H_{K}(M) are the same, then F(K, h) can be the XOR function K⊕H. If the sizes are different, F can, for example, be taken to be one of the two functions described below. We note that h can be considered as an element of the Galois field GF(2^{t}). Consider a generator s of GF(2^{t})*. Then we set:
F(K, h)=h⊕s^{int(K)},
or
F(K, h)=s^{int(K)+int(h)},
where int(K) is an integer, the binary representation of which is K, and similarly int(h) is an integer, the binary representation of which is equal to h.

The particular transformation TR preferably meets the following requirements:
First, it can be computed quickly (at least as fast as the MAC algorithm itself).
Second, it has to be relatively easy to implement TR in any MAC based system, and more particularly such that TR as implemented in the MAC based system is operable to be applied to a MAC-value h of any size.
Third, transformation TR, once applied, is operable to generate an input f of a size that meets the requirements of the MAC based system, and generally the size of h and f shall be the same.
Fourth, transformation TR is a one-way transformation. Moreover, it has to be computationally infeasible to recover the MAC-value h from f. The recovery of h from f is what is commonly referred to in the art as a “hard problem”.

In a particular embodiment of the present invention, TR involves an operation in a group, the reversal of which would require a solution to the discrete logarithm problem for that group. The group is chosen so that this a “hard problem”.

For example, an abstract cyclic group G is defined, having a generator g, for which the discrete logarithm problem is a hard problem. Assume that the numeration of the elements of G requires a binary string of size t. Two examples of such a group include:
1. GF(2^{t})*, where GF(2^{t}) is a finite field of cryptographic size, and g is a selected primitive element of GF(2^{t}); and
2. a finite field GF(2^{t}) is selected, and then an appropriate cryptographic elliptic curve E is defined over GF(2^{t}), as described in N. Koblitz. Elliptic Curve cryptosystems, Mathematics of Computation, 48(1987), 203-209 and I. F. Blake, G. Seroussi, N. Smart, Elliptic Curves in Cryptography, LMS Lecture Notes 265, Cambridge University Press, Cambridge, 2000., and g is a generator of E(GF(2^{t})).

It is well known fact, that the discrete logarithm problem for both groups 1 and 2 described above is a “hard problem” provided that t and E are chosen appropriately. In general, any function that has the one-way property can be used in this context.

TR is a transformation that preferably has a one-way property which impedes or prevents the ability for an input to be derived from the output, even if the algorithm used is known. In one embodiment, TR(h)=w=g^{int(f)} where int(f) is an integer whose binary representation is f. Thus, if f=(a₁, . . . , aₜ), then int(f)=a₁2^{t-1}+ . . . +aₜ2⁰. When TR is applied to the above defined groups, we get TR₁(f)=g^{int(f)} and TR₂=int(f)g for the first and second groups respectively.

As discussed above, application of the above-described method allows the transformation of a hash function into a MAC function by use of a key in the F(K, h) function. If a hash algorithm is represented by H, the following illustrates how hash function H is transformed into MAC function M_{H}.

In an abstract cyclic group G, having a generator g, where the discrete logarithm problem is a hard problem, the elements of the group can be enumerated. For the following discussion, numeration of the elements of G will be considered to required a binary string of length t. If x is a message, and h=H(x) is the hashed message, we can assume that the size of h is t. We can also assume that the size of a key K is the size of h, though this is not always the case.

A keyed function F(K,h) makes use of both the key K and the MAC value h. If F(K,h) takes the input variables as binary strings of length t, F(K,h)ε{0,1}^{t}. This function serves to modify h based on the key K. In an exemplary embodiment, where K and h are the same length, then F(K,h)=K⊕h using the XOR function to modify h in a recoverable manner. If these lengths of K and h are different, functions such as the keyed functions in I. and II. above can be used.

When F(K,h) is computed, a MAC-value of x with key K can be defined as M_{H}(x)=g^{int(F(K,h))}.

One skilled in the art will appreciate that more constructions of F(K,h) are possible without departing from the scope of the present invention. Because K is selectable, and for the interests of security, it is preferable that the length of K be no smaller than the length of h. Thus, there are two cases to examine, that where int(K)>int(h), and that where int(K)=int(h).

For int(K)>int(h), integers q and r can be selected such that
int(K)=int(h)q+r. (i)
Now, F(K,h) can be calculated. F(K,h) is set as
F(K,h)=q+r (ii)
which results in the MAC value being defined as
g^{F(K,h)}=g^{(q+r)}=g^{q}g^{r}. (iii)

Those skilled in the art will appreciate that even if an attacker obtains the MAC value h, it is not possible to calculate q+r without the key K. An attacker may be able to obtain h, or more appropriately int(h) from the message itself. In order to get q and r, int(K) is required to begin application of the division algorithm. Because the key is considered a secret in the system, both K and int(K) are unknown to the attacker. Thus, a simple hashing function can be enhanced to have the features of a MAC function with the application of a simple key function.

For the case where int(K) and int(h) are the about the same size, the formula of equation (i) cannot be applied as q and r have different bounds, while the objective is to have q and r with approximately the same bounds. To address this issue, another expression, W(int(K)) for example, is examined.
W(int(K))=int(K)²+A int(K)+B, (iv)
where A and B are scalar constants. In the simplest case A=B=0, yielding
W(int(K))=int(K)². (v)
Thus, W can be any non-linear function which results in increasing W(int(K)) up to the desired level.

Now, we calculate q and r as
W(int(K))=int(h)q+r (vi)
One skilled in the art will appreciate that a function W can always be defined to satisfy this condition, and such that q and r will have close bounds. At this point, the equation (iii) can be applied.

The above described construction has a feature that should be further examined. F(K,h) can be applied to the output of either a hash or a MAC function. When an initial MAC function is used, a third party can attack it using both key attacks and brute force attacks. When equation (iii) is applied, the integer pairing q and r are calculated naturally, and are uniquely related to K and h. Because K is not known, and h is not directly used in the calculation of (iii), attacking the underlying MAC function becomes problematic. Indeed, to apply either a brute-force or key based attack on the above described method requires a large number of exponentiation operations. This feature can be used to reduce the size of a key.

Although the above-described methods can be carried out with a computational load similar to that of calculating a MAC, in cases of short messages the method may not be as quick as computing a conventional MAC value. The above described method computes a MAC value in approximately the same time for keys of different lengths, as the time required for the calculation of equations (i)-(v) can be considered as constant. Thus, one skilled in the art will appreciate that the size of message for which the above described method will be effective. This can be used as a cut-off length in an automated system unless security requirements are very high.

When the one-way function, such as the above described exponentiation in the Galois Field, the present invention provide a mechanism to increase the size of the message digest, also known as the hash or MAC value. If a larger message digest larger than the hash or MAC value is required, the size of the group in which the final one-way operation is performed can be increased. This will result in an increase in the size of the message digest without requiring the modification of the underlying hash or MAC functions. This allows modifications to be performed in a modular fashion without disrupting existing hash and MAC implementations. Thus, existing implementations of a potentially vulnerable or compromised algorithm, such as SHA-1 can be retained, while the one-way transformation used to generate the final authentication token, which is equivalent in use to the original hash or MAC value, modify the output of the underlying algorithm and thus protect the underlying MAC function from attack. Furthermore, if a message digest of a fixed size, such as 250 bits, is required, the only change required to increase the digest size is to adjust the size of the group in which the final operation is performed and the size of the key. Thus, the output of a 160-bit existing SHA-1 infrastructure can be used to generate a secure message digest of the desired length of 250-bits.

For a given message M, having an associated MAC-value h, a TR transformed value TR(h) is generated and can be appended to message M. Upon receipt of the message M and the TR(h) authentication token, the recipient can verify that the contents of the message have not been tampered with. When TR(h) is evaluated on an elliptical curve in a group (and thus has the form E(GF(2^{t}))), TR(h) can be the x-coordinate of the corresponding point on the elliptical curve. When TR(h) is evaluated in a cyclical group such as GF(2^{t})*, TR(h) is the corresponding element of the field GF(2^{t}). Based on this, and realizing that an effective attack can often be mounted in h, the possibility of an attack on TR(h) should be considered.

It should be understood that without knowledge of the key K, determining h by means of message M alone is computationally infeasible. It would required a brute-force key attack, in which an attacker would have to perform approximately 2^{p-1/2} attempts, where p is the length of key K. Thus, if key K is 160-bits in length, the key attack would require 2⁸⁰ (approximately 1.2×10²⁴) attempts. As described earlier, SHA-1 has a requirement for a key length of 160 bits.

Thus, to realize an attack on h, h must first be recovered from TR(h). When TR(h) is computed using exponentiation in a cyclic group, discrete logarithms are required. Much as multiplication of large prime numbers is considered easy but factoring a composite number having a number of large prime factors is considered difficult, discrete logarithms are considered to be a “hard” problem while exponentiation is considered simple. It is widely believed that the best algorithm to attack a discrete logarithm problem is the application of the so-called “baby-step, giant-step” technique to the group. In the group E(GF(2^{t})), this requires 2^{t/2} calculations. By providing an additional level of security that must be dealt with prior to attacking the underlying hash or MAC function, the application of TR(h) prevents intelligent attack strategies, and reduces attacks back to brute-force methods.

The method of the present invention providing the described transformation of a MAC-value can be used as a universal tool as it is agnostic to the underlying hash or MAC functions, and as described above can operate on a hash or MAC value of any size. Dedicated hardware elements, including custom Application Specific Integrated Circuits (ASIC) and digital signal processors (DSP), can be used in the implementation of the present invention if high speed analysis is required. Alternatively, a general purpose computer can be programmed to execute the methods of the present invention. As is described with relation to the figures, the implementation of a system of the present invention can be logically segmented into a series of generators and engines, that may or may not be discrete elements in an implementation but can be viewed as discrete logical elements nonetheless.

When provided as software for a general purpose computer, embodiments of the present invention can be implemented in Dynamically Linked Libraries (DLL) which are linked to a computer program that utilizes the underlying MAC or hash algorithm, which includes, for example, numerous well known encryption/decryption/authentication utilities.

The present invention can be implemented in a number of environments where hash and MAC functions are used for both data integrity and authentication including digital signatures and certificate authentication. One example of such an implementation is in a secure electronic mail environment, where a number of applications such as Pretty-Good-Privacy (PGP) encryption and Secure/Multipurpose Internet Mail Extensions (S/MIME) use MAC functions such as SHA-1 as a portion of a digital signature implementation. Another implementation environment is in Virtual Private Networks (VPN) which allow users to access a secured network over general purpose networks such as the Internet. The authentication for many VPN's relies upon protocols such as Secure Internet Protocol (IPSec) and Secure Sockets Layer (SSL). Both of these protocols make use of MAC functions such as SHA-1. Thus the vulnerability of VPN's due to the vulnerability in SHA-1 can be mitigated by use of the present invention.

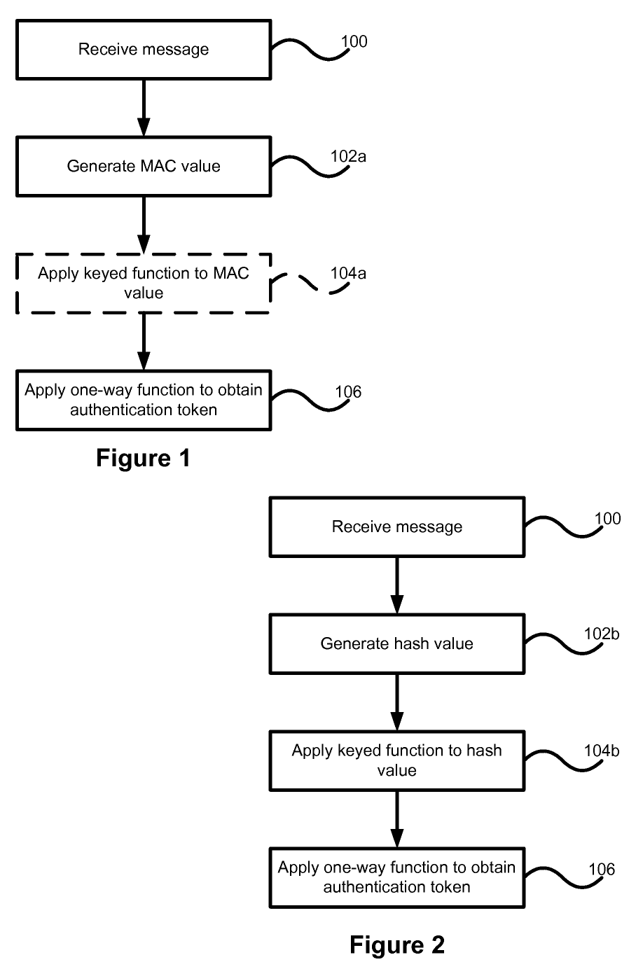

FIGS. 1 and 2 will now be discussed with relation to the above described methods, and to each other. FIG. 1 illustrates the application of an embodiment of the present invention to a MAC function, while FIG. 2 illustrates the application of an embodiment of the present invention to a hashing function to obtain MAC functionality. In step 100 a message is received. In step 102a a MAC function is applied to the function, while in step 102b a hashing function is applied to obtain a MAC value and a hash value respectively. In step 104a and 104b, a keyed function is applied to the MAC and hash values respectively. One skilled in the art will appreciate that step 104b enhances a hash function to operate in the same manner as a MAC function. The application of step 104a is optional. In some embodiments, the application of keyed function can be used wherein the keyed function is a unity function (such that F(K,h)=h) and the output of the keyed function will be identical to the input of the keyed function. In step 106, the one-way function is then applied. The result of the application of the one-way function is the authentication token that replaces the hash and MAC value that is provided in the prior art.

One skilled in the art will appreciate that the keyed function applied in step 104a and 104b (collectively referred to as step 102) can be any reversible keyed function including the functions described earlier such as F(K,h)=K⊕h, and F(K,h)=q+r where int(K)=int(h)q+r where K is the key to the keyed function and h is the hash or MAC value.

In step 106, the one way function is preferably a function that does not have a properly defined inverse function, and is at least as difficult to undo as a brute-force attack would be to implement. One such example is the above described function of exponentiation in a cyclic field, such as a Galois field. Exponentiation is typically easy to perform, especially in a cyclic field, while the discrete logarithm required to invert the operation is computationally complex and thus difficult to perform.

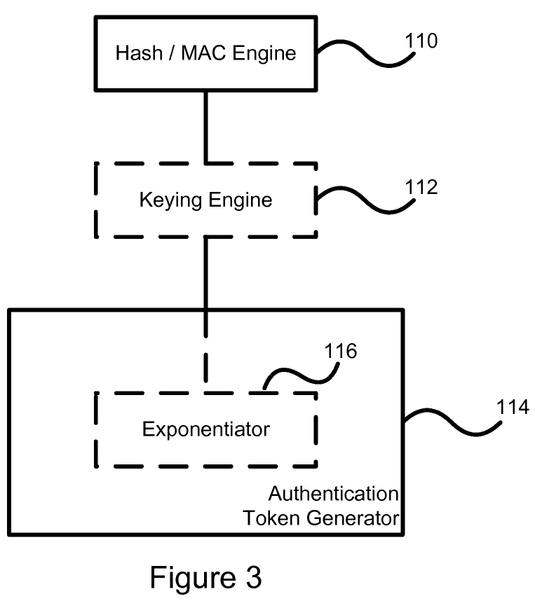

FIG. 3 illustrates an exemplary system of the present invention. In operation, a message is provided to hash/MAC engine 110, which applies either a hash or MAC function to the message to obtain either a hash value or a MAC value respectively, as described above these engines can make use of dedicated hardware or firmware or alternatively can be implemented using software on a general purpose processor. An optional keying engine 112 receives the hash or MAC value and applies a keyed function. This provides the hashing engine with MAC features, and can provide a further level of security to the MAC algorithm. The authentication token generator 114 receives either the hash or MAC value if keying engine 112 is not included or the out output of keying engine 112 if it is included. Generator 114 applies the above-described one way function to obtain an authentication token. This token is associated to the message provided as an input to hash/MAC engine 110, and can easily be reproduced given the message and the appropriate keys, but due to the one way nature of the function applied to generate the token, neither the message nor any key used in the creation of the token can be recovered using only the token. As described above, the token generator can generate tokens that are larger than the length of the hash or MAC value simply by performing the one way function in a space having as many enumerated elements as the desired length of the token. Generator 114 may optionally include an exponentiator 116 for obtaining the token by exponentiation of the input value, preferably this is performed in a cyclic group, but can also be controlled using modulo arithmetic to restrict the upper limit on the exponentiated value.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of enhancing the security of a Message Authentication Code (MAC) function having a MAC function key, the method comprising:
applying the MAC function to a message to obtain a MAC value; and
generating an authentication token associated with the message, to prevent direct access to the MAC value, by applying a one-way function to the MAC value.

2. The method of claim 1 wherein the MAC function is a SHA-based MAC function.

3. The method of claim 1 further including applying a keyed function to the MAC value prior to applying the one way function.

4. The method of claim 3 wherein the keyed function has a keyed function key distinct from the MAC function key.

5. The method of claim 1 wherein the one-way function is applied in a cyclic group.

6. The method of claim 5 wherein the cyclic group is a Galois field having a generator.

7. The method of claim 6 wherein the Galois field is defined as GF(2t).

8. The method of claim 6 wherein the one way function includes exponentiation of the MAC value in the Galois field using the generator.

9. The method of claim 1 wherein the length of the authentication token is identical to the length of the MAC value.

10. The method of claim 1 wherein the length of the authentication token exceeds the length of the MAC value.

11. The method of claim 1 wherein the one way function is applied in a cyclic group having a size equal to the length of the authentication token.

12. A method of enhancing a hashing function to operate as an enhanced Message Authentication Code (MAC) function comprising:
applying the hashing function to a message to obtain a hash value;
applying a keyed function to the hash value to obtain a keyed hash value; and
generating an authentication token associated with the message, to prevent direct access to the hashed value, by applying a one-way function to the keyed hash value.

13. The method of claim 12 wherein the hash function is the MD5 function.

14. The method of claim 12 wherein the one-way function includes exponentiation of the hashed message in cyclic group.

15. The method of claim 12 wherein the length of the authentication token exceeds the length of the hashed message.

16. The method of claim 15 wherein the one way function is applied in a cyclic group having a size equal to the length of the authentication token.

17. A system for generating an authentication token associated with an input message comprising:
a message authentication code engine for generating a message authentication value associated with the message; and
an authentication token generator for performing a one-way function on the message authentication value to generate the authentication token.

18. The system of claim 17 wherein the authentication token generator includes an exponentiator for generating the authentication token by exponentiating the message authentication value in a cyclic finite group.

19. The system of claim 17 further including:
a keying engine for applying a keyed function to the message authentication value to obtain a keyed message authentication value and for providing the authentication token generator with the keyed authentication value;
wherein the authentication token generator performs the one-way function on the keyed message authentication value to generate the authentication token.

20. A system for generating an authentication token associated with an input message comprising:
a hashing engine for generating a hash value associated with the message;
a keying engine for applying a keyed function to the hash value to obtain a keyed hashed value; and
an authentication token generator for performing a one-way function on the keyed hash value to generate the authentication token.

21. The system of claim 20 wherein the authentication token generator includes an exponentiator for generating the authentication token by exponentiating the keyed hash value in a cyclic finite group.
